(19) United States
(12) Patent Application Publication
(10) Pub. No.: US 2006/0290224 A1
(43) Pub. Date: Dec. 28, 2006

(54) Generator of electrical energy

(76) Inventor: Faustino Sabater Perez, Madrid (ES)

Correspondence Address: Faustino SABATER PEREZ, C/VICTOR DE LA SERNA 3-5 (PARKING), MADRID, 28016, ES

(21) Appl. No.: 11/248,424

(22) Filed: Oct. 13, 2005

(30) Foreign Application Priority Data
Jun. 24, 2005 (ES) P200501558

(51) Int. Cl. H02K 1/00; H02K 3/00; H02K 19/26; H02K 23/02

(52) U.S. Cl. 310/181

(57) ABSTRACT

Generator (1) of electrical energy made up of two permanent magnets (3) arranged one after another at a set distance; a magnetic field separator disk (5), which acts between both magnets; a rolled-up coil (7) on the prolongation of the nucleus of one of the permanent magnets (3) and an impulse mechanism for the rotating disk that can be a wind turbine (10), a very low-powered electrical motor, or any other external means.

The field separator is made up of an iron disk, that is, of ferromagnetic material. Near its periphery, a series of four or more windows (5.1) has been made, allowing the poles of the permanent magnets to interact directly. The distance between each permanent magnet and the separator disk is about two millimetres.

### OBJECT OF THE INVENTION

This invention is related to a new mechanism for generating electrical energy with permanent magnets.

### BACKGROUND OF THE INVENTION

Magnetism is a phenomenon that has been known to humanity since ancient times. Its origin was due to the discovery, made by the Greeks over 2,000 years ago, of a mineral (in a region of Asia Minor called Magnesia) that had the capability to attract iron. Today this mineral is known as “magnetite”.

The Chinese had already discovered, around the year 1000, that if a long piece of magnetite was arranged on a floating object in water and allowed to move freely, it always aligned itself in the same direction (North-South). This mineral later became known as natural magnet.

The observations and knowledge that were gradually produced regarding natural magnets throughout the centuries lead to the invention of the magnetic compass, whose use for orientation soon extended to Europe by way of the Middle East, and played a decisive role in the development of navigation by sea, bringing about the discovery of new lands, facilitating travel, the transportation of people and merchandise, etc. However, the explanation of the physics of magnetism remained as a mystery of nature for a long time.

Much later on, in the year 1820, the Danish scientist H. C. Oersted discovered the interaction between electricity and magnetism through an experiment that consisted of situating a compass near a wire through which an electrical current was circulating. He was able to prove that in such conditions, the needle of the compass tended to point in a perpendicular direction in relation to the wire through which the electrical current was circulating.

Once it was made evident that electrical charges in movement produce magnetic effects, it seemed necessary to advance towards a deeper understanding of magnetic phenomena.

With the advancement of studies and experiments, it was shown that the circulation of an electrical current through a conductor induces a magnetic field around it, the intensity of which at any point is proportional to that current, and inverse to the distance of the conductor. The opposite cause and effect was also discovered, that is, that a magnet in movement induces an electrical current in a fixed conductor within its magnetic field. Magnetic induction was discovered by the British scientist and inventor Michael Faraday in 1831: if a conductor moves through a magnetic field, or is situated in the environs of a fixed conduction circuit whose intensity can vary, a current is established or induced in the conductor.

The opposite principle to this one was observed by the French physicist André Marie Ampere: if a current is sent through a conductor within a magnetic field, the current will produce mechanical force on said conductor.

These two important scientific advances later lead to electromagnets, and after that, to electrical energy motors and generators.

Although the phenomenon of magnetism has been known of since time immemorial, and the relationship between electricity and magnetism has been explained through the Laws of Maxwell, new applications and mechanisms such as the one described below are continuously being developed.

### DESCRIPTION OF THE INVENTION

This invention consists of a new generator of electrical energy made up of two or more permanent magnets arranged one after another at a set distance with their opposite poles facing one another; a rotating disk separating the magnetic field, which acts between both magnets; a rolled-up coil on the prolongation of the nucleus of the permanent magnets and an impulse mechanism for the rotating disk that can be a wind turbine, a very low-powered electrical motor or any other external means.

The field separator is made up of an iron disk, that is, of ferromagnetic material. Near its periphery, a series of four or more windows has been made, allowing the poles of the permanent magnets to interact directly.

The distance between each permanent magnet and the separating disk is of just two millimetres.

The assembly operates in the following way. When one of the windows of the disk is sent between the two permanent magnets arranged N-N, the magnetic field varies through repulsion and likewise, when the solid part of the separating disk passes through the permanent magnets varies by attraction, thus producing a variation in the magnetic field, and therefore, a variation in the intensity of the field intensity, which induces electromotor force in the terminals of the coils. The difference between the generators currently known is that when a charge, motors, etc. are applied, the known counter-field that brakes and heats up the generator is not produced, and the disk continues to rotate with minimal resistor. This means that as long as the disk rotates, the resulting magnetic field varies at the same rotation speed as the disk, thus generating an alternate tension between the terminals of the coil, which is directly proportional to the variation of the magnetic flow and inversely proportional to the time that has lapsed. The well known mathematical formula is: E=dΦ/dt

When the disk receives impulse from an external source such as a wind turbine, the sinusoidal wave that is generated is quite variable, since it depends on the speed of the wind, which is why in order to use wind power to its maximum potential, the wave of tension obtained can be rectified with a diode bridge and transformed into a continuous current that can be used to charge a battery.

With a small part of the stored electrical charge in this battery, a small, continuous current motor can be put in operation that will make the disk rotate when there is no wind. The assembly is thus completely autonomous and the resulting electrical charge can be used for any purpose chosen by the user.

The generator can be made with eight coils and eight magnets, that is, four on one side and four on the other, although depending on the diameter of the disk, the number of coils and magnets can be increased.

Each coil can individually feed a charge or they can all be connected in parallel. The same rotation axis can also be connected to several generators.

### DESCRIPTION OF THE DRAWINGS

In order to complement the description of this invention, and to offer an improved understanding of its features, the present disclosure is accompanied by a figure, in which as a non-limiting illustration the following drawing is shown, the main components of which are the following.

(1) Generator

(2) Support

(3) Permanent magnet
(3.1) Magnetic field line

(4) Platen

(5) Magnetic field separating disk
(5.1) Separator window

(6) Rotation axis
(6.1) Ring

(7) Coil
(7.1) Iron nucleus

(8) Resistor

(9) Switch

(10) Wind turbine

FIG. 1A is a raised view of the generator (1), in which its main components are shown: the support (2), the magnets (3) with their NORTH-NORTH poles facing one another, the separating disk (5), the coil 7 and the resistor (8).

FIG. 1B, is a raised view of the generator (1), in which the support (2), the platen (4), the separating disk (5), the window (5.1), the rotation axis (6), the coil (7) and the resistor (8) are shown.

FIG. 2A is a raised view of the generator (1), in which its main components are shown: the support (2), the magnets (3) with their NORTH-NORTH poles facing one another, in this case adding together their field intensity, the separating disk (5) rotated 90°, the coil (7) and the resistor (8).

FIG. 2B is a raised view of the generator (1), in which the support (2), the platen (4), the separating disk (5) rotated 90°, the window (5.1), the rotation axis (6), the coil 7 and the resistor (8) are shown.

FIG. 3 is an example of the generator (1) whose rotation axis (6) is powered by a wind turbine.

FIG. 4A is an example of a generator with four coils on one side and four coils on the other.

### PREFERRED EMBODIMENT OF THE INVENTION

Among the different types of generators of electrical energy that can be built based on this invention, the preferred embodiment is the one disclosed below.

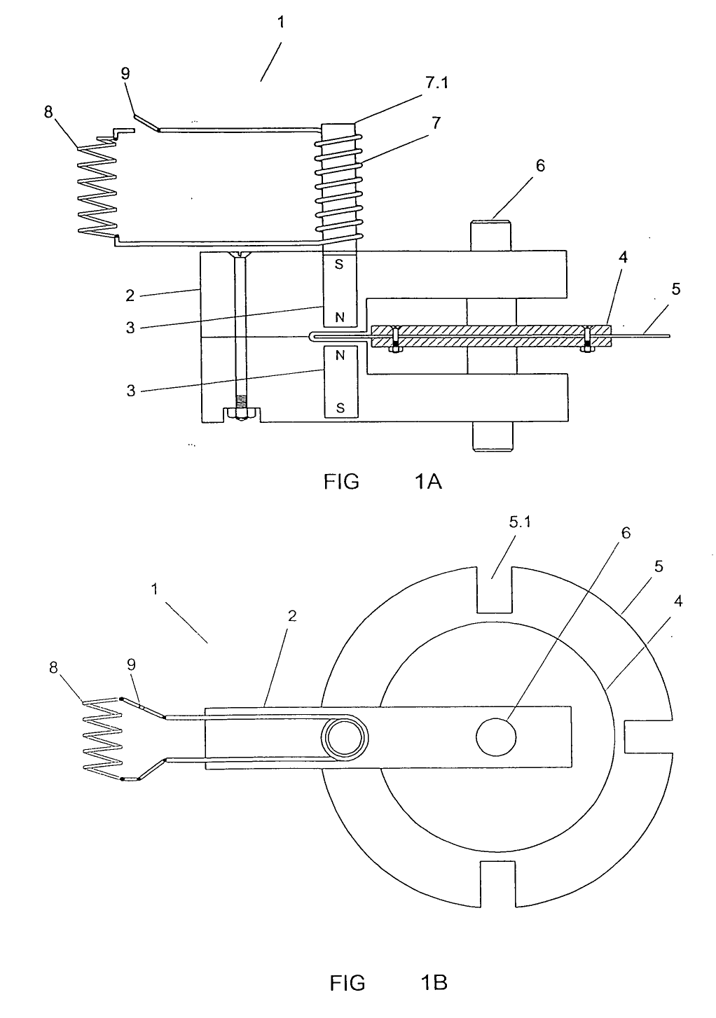

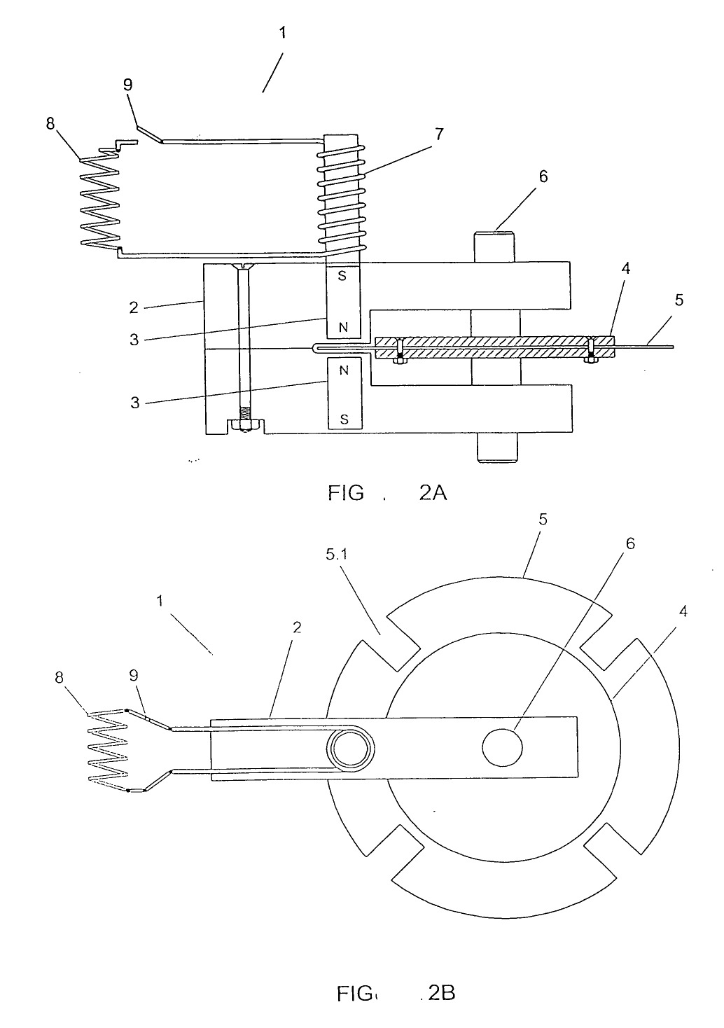

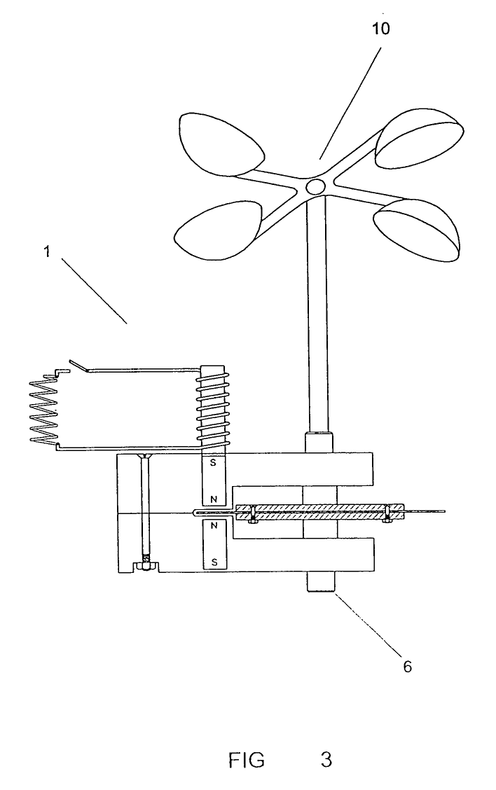

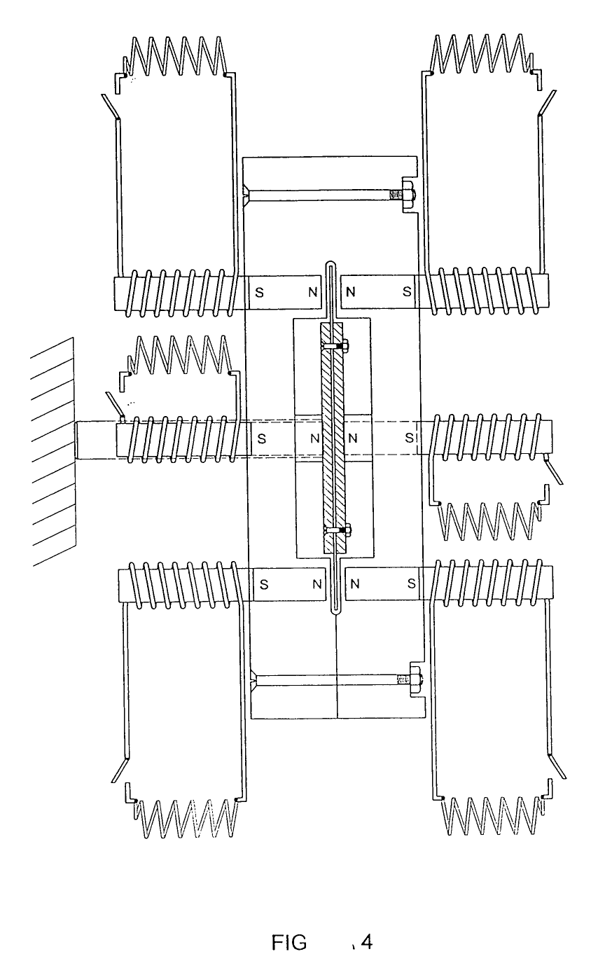

To build this basic generator (1) of electrical energy, one starts out with two permanent magnets (3) with rectangular or circular sections, arranged on a U-shaped support (2) as can be seen in FIGS. 1A and 1B, with the NORTH-NORTH poles facing one another. These magnets are in contact with the coil (7) by way of the iron nucleus (7.1). On the TERMINALS of this coil (7) an E.M.F. (electro-motor force) is generated due to the variation of the field intensity of the permanent magnet (3) that is in contact with said coil (7), when the separating disk (5) turns on its rotation axis (6) powered by a wind turbine or any other motor or mechanism.

The separating disk (3) of ferromagnetic material, has a series of windows round its periphery that create a variation in the magnetic reluctance in the space between both magnets within a range of a maximum when it passes the window and a minimum when it passes the solid part of the disk. The variation of magnetic force in the time unit creates the EMF in the terminals of the coil.

Having sufficiently described the nature of the present invention, as well as a practical application of the same, we only need add that modifications may be carried out in both its shape and materials and procedure for production, as long as they do not substantially alter the characteristics claimed below.

1-Generator of electrical energy characterised in that the basic version is made up of a support, two permanent magnets, a coil, a magnetic field separating disk, a rotation axis of the disk and a wind turbine.

2-Generator of electrical energy according to the first claim, characterised in that the two magnets are fixed onto the support, arranged one after the other with their equal NORTH-NORTH poles facing one another, separated by four millimetres.

3-Generator of electrical energy according to previous claims, characterised in that the separating disk of the magnetic field included between both magnets rotates on its axis powered by a wind turbine or by any other type of power source.

4-Generator of electrical energy according to previous claims, characterised in that the disk separating the magnetic field is a 2 mm-thick round ferromagnetic sheet, provided with windows along its periphery similar to the gaps found between the teeth of a gear.

5-Generator of electrical energy according to previous claims, characterised in that, the turning of the separating disk brings about the variation of the magnetic field between both permanent magnets between a maximum and a minimum when it passes a window and then when it passes one of the solid parts of the disk.

6-Generator of electrical energy according to previous claims characterised in that, due to the variation of the intensity of the magnetic field in the ferromagnetic nucleus of the coil, an electromotor force is generated between its terminals that is directly proportional to the variation speed of the intensity of the magnetic flow.

7-Generator of electrical energy according to the first claim characterised in that the ferromagnetic nucleus of the coil is in direct contact with its corresponding permanent magnet.

8-Generator of electrical energy according to the first claim, characterised in that the industrial version is made up of a support, eight permanent magnets, eight coils, a magnetic field separating disk, a rotation axis of the disk and a wind turbine.
